(19) United States
(12) Patent Application Publication
(10) Pub. No.: US 2026/0100428 A1
(43) Pub. Date: Apr. 9, 2026

(54) APPARATUS AND METHOD FOR DIAGNOSING AN OVERCURRENT OF A BATTERY

(71) Applicants: HYUNDAI MOTOR COMPANY, Seoul (KR); KIA CORPORATION, Seoul (KR)

(72) Inventor: Dong Wan Ko, Hwaseong-si (KR)

(73) Assignees: HYUNDAI MOTOR COMPANY, Seoul (KR); KIA CORPORATION, Seoul (KR)

(21) Appl. No.: 19/246,148

(22) Filed: Jun. 23, 2025

(30) Foreign Application Priority Data
Oct. 8, 2024 (KR) 10-2024-0136350

(51) Int. Cl. H01M 10/42; G01K 3/00; H01M 10/48

(52) U.S. Cl. CPC H01M 10/4285; G01K 3/005; H01M 10/486

(57) ABSTRACT

An apparatus for diagnosing an overcurrent of a battery includes a fuse temperature measurement unit which measures a temperature of a fuse through which a current of a battery flows and an overcurrent diagnosis unit which diagnoses an overcurrent state of the battery based on a measured fuse temperature.

### CROSS-REFERENCE TO RELATED APPLICATION

This application claims priority to Korean Patent Application No. 10-2024-0136350, filed Oct. 8, 2024, the entire disclosure of which is hereby incorporated by reference.

### FIELD

The present disclosure relates to an apparatus and a method for diagnosing an overcurrent of a battery, and more particularly, to an apparatus and a method for diagnosing an overcurrent of a high voltage battery used for eco-friendly vehicles.

### BACKGROUND

Batteries used for eco-friendly vehicles, such as electric vehicles (EV), hybrid electric vehicles (HEV), or plug-in hybrid electric vehicles (PHEV) are high-voltage batteries which generate high voltages by connecting a large number of battery cells with the same specification in series/parallel.

However, when an overcurrent occurs in such a high-voltage battery, the temperature of the battery rapidly rises to greatly increase the risk of fire.

Accordingly, when a magnitude of a charging current of a battery exceeds a predetermined percentage of a maximum current value on a charging map, the battery management system (BMS) turns off the relay to block the flow of the charging current, thereby preventing the overcurrent of the battery. If overcurrent flows through the battery, a fuse is disconnected to protect the charging system and a power electric (PE) system.

However, as illustrated in FIG. 1, there may be a weak part (for example, when 300 A of current flows for 9 seconds) which is not covered by a BMS diagnosis area which is diagnosed as an overcurrent by the BMS (for example, when 100 A or higher of flows for 10 seconds or longer) and a fuse blocking area in which a fuse is disconnected to block the overcurrent.

Further, conventionally there has been a control logic which protects the overcurrent only during the vehicle charging (battery charging state), but there has not been control logic which protects the battery overcurrent while the vehicle is driving (battery discharging state) or is parked (a battery standby state), and thus, there is still a problem in that there is a risk of fire due to the battery overcurrent while the vehicle is driving or parked.

### SUMMARY

The present disclosure is created to solve the problems as described above and the present disclosure provides an apparatus and a method for diagnosing an overcurrent of a battery to prevent the overcurrent of a battery while a vehicle is driving (battery discharging state) or parked (battery standby state).

The present disclosure further provides an apparatus and a method for diagnosing an overcurrent of a battery to diagnose an overcurrent state of a battery by measuring a temperature of a fuse through which charging and/or discharging current of the battery flows.

The present disclosure also provides an apparatus and a method for diagnosing an overcurrent of a battery which divides an overcurrent state of a battery into a plurality of levels to perform an optimal response appropriate for each level.

Objects and advantages of the present disclosure are not limited to the above-mentioned objects and advantages, and other objects and advantages of the present disclosure, which are not mentioned, should be understood through the following description, and should become apparent from embodiments of the present disclosure. It is also to be understood that the objects and advantages of the present disclosure may be realized by means and combinations thereof set forth in claims.

According to an aspect of the present disclosure, an apparatus for diagnosing a battery overcurrent includes a fuse temperature measurement unit which measures a temperature of a fuse through which a current of a battery flows and an overcurrent diagnosis unit which diagnoses an overcurrent state of the battery based on a measured fuse temperature.

When the measured fuse temperature is higher than a highest fuse temperature in each area on a discharging power map of the battery by a predetermined threshold or more (or based on the measured fuse temperature being higher than a highest fuse temperature in each area on a discharging power map of the battery by a predetermined threshold or more), the overcurrent diagnosis unit may diagnose the overcurrent state as a first level of overcurrent.

When a change rate of the measured fuse temperature is equal to or higher than a predetermined first threshold, the overcurrent diagnosis unit may diagnose the overcurrent state as a second level of overcurrent.

The apparatus may further include a battery control unit which blocks a current flow of the battery when the overcurrent state is determined as the second level of overcurrent (or based on the overcurrent state being determined as the second level of overcurrent).

According to another aspect of the present disclosure, a method for diagnosing a battery overcurrent includes measuring a temperature of a fuse through which a current of a battery flows; and diagnosing an overcurrent state of the battery based on a measured fuse temperature.

Diagnosing the overcurrent state of the battery may include, when the measured fuse temperature is higher than a highest fuse temperature in each area on a discharging power map of the battery by a predetermined threshold or more (or based on the measured fuse temperature being higher than a highest fuse temperature in each area on a discharging power map of the battery by a predetermined threshold or more), diagnosing the overcurrent state as a first level of overcurrent.

Diagnosing the overcurrent state of the battery may include, when a change rate of the measured fuse temperature is equal to or higher than a predetermined first threshold (or based on a change rate of the measured fuse temperature being equal to or higher than a predetermined first threshold), diagnosing the overcurrent state as a second level of overcurrent.

The method may further include blocking a current flow of the battery when the overcurrent state is determined as the second level of overcurrent (or based on the overcurrent state being determined as the second level of overcurrent).

According to yet another aspect of the present disclosure, an apparatus for diagnosing a battery overcurrent includes a fuse temperature measurement unit configured to measure a temperature of a fuse through which a current of a battery flows, and an overcurrent diagnosis unit configured to determine a overcurrent level of an overcurrent state of the battery based on a measured fuse temperature.

The overcurrent diagnosis unit may divide the overcurrent state of the battery into a plurality of overcurrent levels.

The overcurrent state of the battery may be divided into the plurality of overcurrent levels based on an overcurrent magnitude.

The overcurrent state of the battery may be divided into the plurality of overcurrent levels based on a risk level.

Based on the measured fuse temperature being higher than a highest fuse temperature in each area on a discharging power map of the battery by a predetermined threshold or more, the overcurrent diagnosis unit may diagnose the overcurrent state as a first level of overcurrent.

Based on a change rate of the measured fuse temperature being equal to or higher than a predetermined first threshold, the overcurrent diagnosis unit may diagnose the overcurrent state as a second level of overcurrent.

According to one or more embodiments of the present disclosure, an overcurrent state of a battery is diagnosed by measuring a temperature of a fuse through which a current of a battery flows, thereby preventing the overcurrent of the battery when the vehicle is being charged (battery charging state), and when the vehicle is driving (battery discharging state) or parked (battery standby state).

In addition, according to one or more embodiments of the present disclosure, the overcurrent state of the battery is divided into a plurality of levels and optimal response appropriate for each level is performed, thereby efficiently charging/discharging the battery while preventing the overcurrent of the battery.

### BRIEF DESCRIPTION OF THE DRAWINGS

The above and other aspects, features, and advantages of the present disclosure should become apparent from the detailed description of the following aspects in conjunction with the accompanying drawings, in which:

FIG. 1 is a view for explaining a battery overcurrent diagnosis method according to the related art;

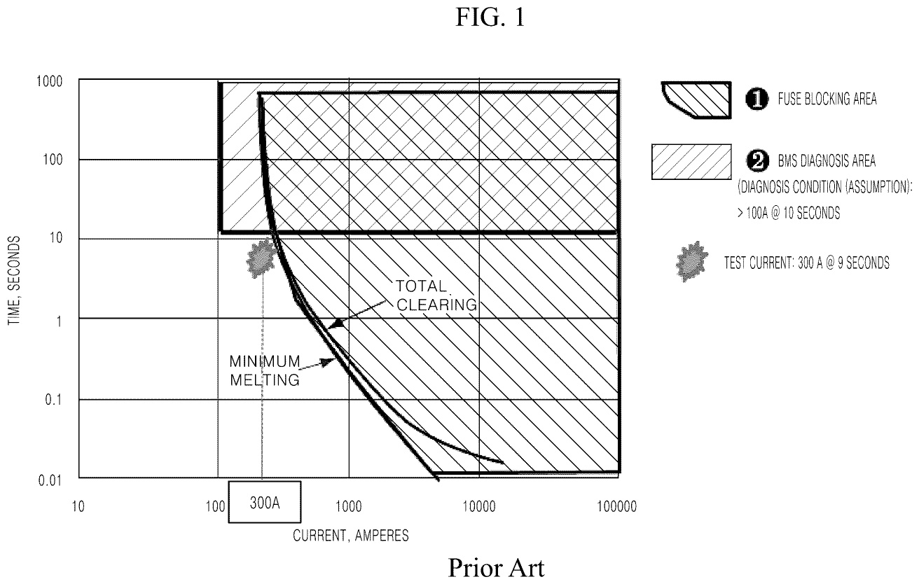

FIG. 2 is a diagram of a battery overcurrent diagnosis apparatus according to an embodiment of the present disclosure;

FIG. 3 is a flowchart of a battery overcurrent diagnosis method according to an embodiment of the present disclosure;

FIG. 4 is a view illustrating a discharging power map of a battery to diagnose a first level of overcurrent according to an embodiment of the present disclosure; and.

FIG. 5 is a view for explaining a temperature change rate of a fuse to diagnose a second level of overcurrent according to an embodiment of the present disclosure.

### DETAILED DESCRIPTION

Hereinafter, reference is made in detail to embodiments of the present disclosure, examples of which are illustrated in the accompanying drawings and described below, and wherever possible, the same or similar elements are denoted by the same reference numerals even though they are depicted in different drawings and a redundant description thereof has thus been omitted. In the following description of embodiments, suffixes, such as “module”, “unit,” and “part”, are provided or used interchangeably merely in consideration of ease in statement of the specification, and do not have meanings or functions distinguished from one another. In the following description of embodiments of the present disclosure, a detailed description of known functions and configurations incorporated herein has been omitted when it may make the subject matter of the present disclosure rather unclear. Further, the accompanying drawings are given to describe embodiments of the present disclosure, and should not be construed as being limited to embodiments set forth herein, and it should be understood that embodiments of the present disclosure are provided only to completely disclose the disclosure and cover modifications, equivalents or alternatives which come within the scope and technical range of the disclosure.

In the following description of embodiments, terms, such as “first” and “second”, are used only to describe various elements, and these elements should not be construed as being limited by these terms. These terms are used only to distinguish one element from other elements.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present.

When a component, unit, device, element, apparatus, or the like of the present disclosure is described as having a purpose or performing an operation, function, or the like, the component, unit, device, element, apparatus, or the like should be considered herein as being “configured to” meet that purpose or to perform that operation or function. Each component, unit, device, element, apparatus, and the like may separately embody or be included with a processor and a memory, such as a non-transitory computer readable media, as part of the apparatus.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

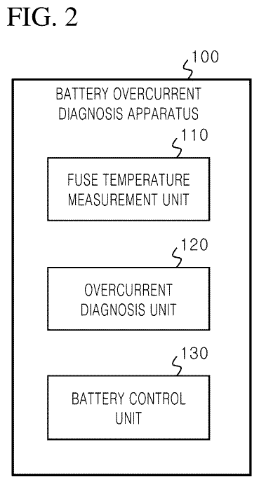

Hereinafter, a battery overcurrent diagnosis apparatus and method according to one or more embodiments of the present disclosure are described in detail with reference to FIGS. 2-5.

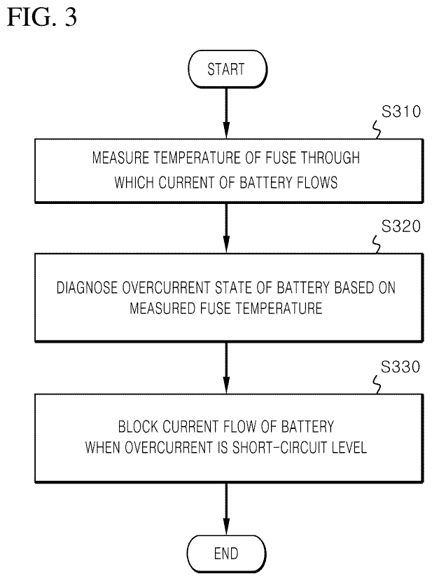

FIG. 2 is a system diagram of a battery overcurrent diagnosis apparatus according to an embodiment of the present disclosure, and FIG. 3 is a flowchart of a battery overcurrent diagnosis method according to an embodiment of the present disclosure.

Referring to FIG. 2, a battery overcurrent diagnosis apparatus 100 according to an embodiment of the present disclosure includes a fuse temperature measurement unit 110, an overcurrent diagnosis unit 120, and a battery control unit 130.

The fuse temperature measurement unit 110 measures a temperature of a fuse through which a charging current and/or discharging current of a battery flows (see step S310 of FIG. 3).

The fuse is provided between the battery and the charging system and/or between the battery and a power electric (PE) system to be electrically connected so that the charging current and/or the discharging current of the battery flows through a fuse.

When the charging current and/or the discharging current of the battery flows through the fuse, a temperature of the fuse rises corresponding to or depending on the magnitude of the current and an electrically conducted time, and thus, according to an embodiment of the present disclosure, an overcurrent state of a battery is diagnosed by measuring a temperature of the fuse.

Specifically, the overcurrent diagnosis unit 120 diagnoses an overcurrent state of the battery based on the fuse temperature measured by the fuse temperature measurement unit 110 (see step S320 of FIG. 3).

According to an embodiment of the present disclosure, the overcurrent diagnosis unit 120 divides an overcurrent state of the battery into a plurality of levels by considering an overcurrent magnitude and a risk level to diagnose the overcurrent state. For example, the overcurrent diagnosis unit 120 divides the overcurrent state of the battery into a first level of overcurrent which is a relatively low overcurrent state and a second level of overcurrent which is a short-circuit level.

When a fuse temperature measured by the fuse temperature measurement unit 110 is higher than a highest fuse temperature in each area on the discharging power map of the battery by a predetermined threshold or more, the overcurrent diagnosis unit 120 diagnoses the first level of overcurrent and notifies the user (driver).

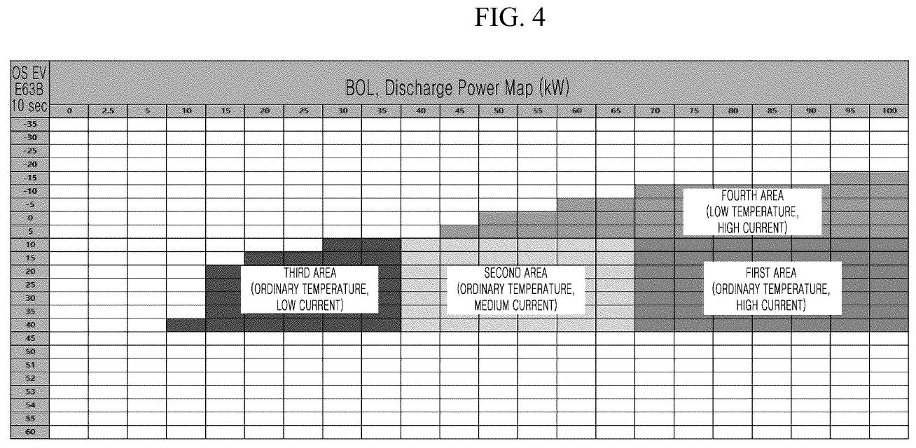

FIG. 4 is a view illustrating a discharging power map of a battery to diagnose a first level of overcurrent according to an embodiment of the present disclosure.

The battery discharging power map is a map in which a maximum discharging power is determined for each area divided based on a temperature and a state of charge (SOC) of the battery. However, according to an embodiment of the present disclosure, a highest fuse temperature which maintains a normal current flow for each area on the discharging power map is set and stored.

For example, in FIG. 4, the discharging power map of the battery is divided into a first area corresponding to an ordinary temperature/high current, a second area corresponding to an ordinary temperature/medium current, a third area corresponding to an ordinary temperature/low current, and a fourth area corresponding to a low temperature/high current. In the first area, the highest fuse temperature may be set to 55° C., in the second area, the highest fuse temperature may be set to 50° C., in the third area, the highest fuse temperature may be set to 45° C., and in the fourth area, the highest fuse temperature may be set to 15° C.

On the discharging power map, the highest fuse temperature in each area may be calculated or determined by a correlation test between a battery discharging current and a fuse temperature. However, according to an embodiment of the present disclosure, by considering that a fuse deteriorates in accordance with the deterioration of the battery, when the highest fuse temperature for each area on the discharging power map is calculated or determined, the state of health (SOH) of the battery is reflected or considered. For example, the highest fuse temperature for each area on the discharging power map at the current timing is calculated or determined by multiplying the highest fuse temperature in each area on the discharging power map set based on a new product state (100% of SOH) by the SOH at the current timing. Accordingly, when the SOH is updated, the highest fuse temperature in each area on the discharging power map is also updated.

A threshold used to diagnose the first level of overcurrent may be set as a predetermined percentage or a predetermined temperature and may be set to be different for each area. For example, in the case of the first area in which the highest fuse temperature may be set to 55° C., a predetermined percentage of 5% (i.e., 2.75° C.) or a predetermined temperature of 2.75° C. may be set as a threshold and in the case of the second area in which the highest fuse temperature may be set to 50° C., a predetermined percentage of 5% (i.e., 2.5° C.) or a predetermined temperature of 2.5° C. may be set as a threshold.

Further, according to an embodiment of the present disclosure, the threshold used to diagnose the first level of overcurrent may be set in accordance with (or based on) the charging overcurrent condition of the battery.

For example, when the charging overcurrent condition of the battery is that 5% or higher of the highest charging current for each area on the charging map flows, the threshold used to diagnose the first level of overcurrent may be set to 5% of the highest fuse temperature in each area on the discharging power map.

As described above, when the temperature of the fuse is higher than the highest fuse temperature in each area on the discharging power map of the battery by a predetermined threshold or more, the overcurrent diagnosis unit 120 diagnoses the first level of overcurrent and notifies the user (driver).

In an embodiment, when the temperature of the fuse is higher than the highest fuse temperature in each area on the discharging power map of the battery by a predetermined threshold or more only one time, the overcurrent diagnosis unit 120 does not immediately diagnose the first level of overcurrent, and when the temperature of the fuse which is higher than the highest fuse temperature in each area on the discharging power map of the battery by a predetermined threshold or more for a predetermined number of times (for example, three times) or is maintained for a predetermined time (for example, 3 seconds), the overcurrent diagnosis unit may be implemented to diagnose the first level of overcurrent at that time.

When a temperature change rate of a fuse measured by the fuse temperature measurement unit 110 is equal to or higher than a predetermined first threshold, the overcurrent diagnosis unit 120 diagnoses the second level of overcurrent and notifies the user (driver).

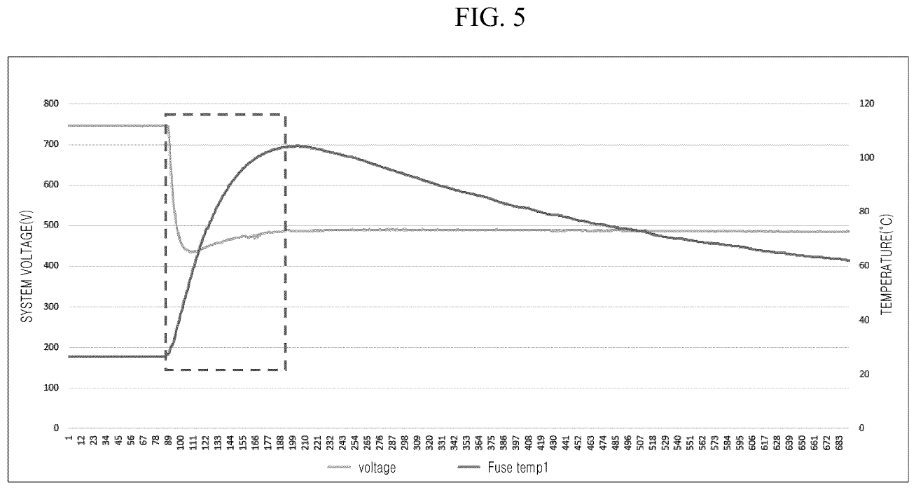

FIG. 5 is a view for explaining a temperature change rate of a fuse to diagnose as a second level of overcurrent according to an embodiment of the present disclosure.

Referring to FIG. 5, when the battery overcurrent occurs (see dotted rectangular area), the system voltage rapidly drops and the fuse temperature rapidly rises. According to an embodiment of the present disclosure, the overcurrent at a short-circuit level is diagnosed in advance based on the temperature change rate of the fuse.

The temperature change rate of the fuse refers to a change rate of the fuse temperature for a unit time, so that when the temperature change rate of the fuse is equal to or higher to a predetermined first threshold (for example, a temperature change rate of the fuse is equal to or higher than 1° C./s), the overcurrent diagnosis unit 120 diagnoses a second level of overcurrent which is an overcurrent state at a short-circuit level.

When the overcurrent state is diagnosed as the second level of overcurrent, the battery control unit 130 which interworks with the battery diagnosis unit 120 turns off the relay to block the current flow of the battery (see step S330 of FIG. 3) to protect a charging system and a power electric (PE) system and prevent the damage of the fuse.

After turning off the relay to block the current flow of the battery, if the temperature change rate of the fuse measured by the fuse temperature measurement unit 110 is equal to or higher than a predetermined second threshold value (for example, when the temperature change rate of the fuse is equal to or higher than 0° C./s), the battery diagnosis unit 120 continuously maintains a relay-off state and if the temperature change rate of the fuse measured by the fuse temperature measurement unit 110 is lower than a predetermined second threshold value (for example, when the temperature change rate of the fuse is lower than 0° C./s), the battery diagnosis unit 120 turns on the relay to recover the current flow of the battery. In this case, the battery diagnosis unit 120 maintains the diagnosis of the first level of overcurrent and notifies the user (driver).

When the temperature change rate of the fuse is equal to or higher than the predetermined first threshold only one time, the overcurrent diagnosis unit 120 does not immediately diagnose the second level of overcurrent and if the case when the temperature change rate of the fuse is equal to or higher than the predetermined first threshold occurs for a predetermined number of times (for example, three times) or is maintained for a predetermined time (for example, 3 seconds), the overcurrent diagnosis unit is implemented to diagnose the second level of overcurrent. Similarly, when the temperature change rate of the fuse is lower than the predetermined second threshold only one time, the overcurrent diagnosis unit 120 does not immediately turn on the relay and if the case when the temperature change rate of the fuse is lower than the predetermined first threshold occurs for a predetermined number of times (for example, three times) or is maintained for a predetermined time (for example, 3 seconds), the overcurrent diagnosis unit is implemented to turn on the relay at that time.

In the specification (particularly, in the claims) of the present disclosure, use of the term “the” or “said” and similar referential terms may refer to both the singular and the plural. In addition, when a range is stated in the present disclosure, the statement includes one or more embodiments to which individual values within the range are applied (unless there is a statement to the contrary), and is the same as a statement of the individual values constituting the range in the detailed description of the present disclosure.

Unless there is a statement of an explicit order or a statement to the contrary regarding steps constituting the method according to the present disclosure, the steps may be performed in any appropriate order. The present disclosure is not necessarily limited by the described order of the steps. Use of any examples or illustrative terms (for example, and the like) in the present disclosure is merely to describe the present disclosure in detail, and unless limited by the claims, the scope of the present disclosure is not limited by the examples or illustrative terms. Further, those having ordinary skill in the art should appreciate that various modifications, combinations, and changes may be made according to design conditions and factors within the scope of the appended claims or their equivalents.

Therefore, the spirit of the present disclosure should not be limited to the above-described embodiments, and the scope of the appended claims described below as well as all scopes equivalent to or equivalently changed from the claims are within the scope of the spirit of the present disclosure.

What is claimed is:

1. An apparatus for diagnosing a battery overcurrent, the apparatus comprising:
a fuse temperature measurement unit configured to measure a temperature of a fuse through which a current of a battery flows; and
an overcurrent diagnosis unit configured to diagnose an overcurrent state of the battery based on a measured fuse temperature.

2. The apparatus according to claim 1, wherein based on the measured fuse temperature being higher than a highest fuse temperature in each area on a discharging power map of the battery by a predetermined threshold or more, the overcurrent diagnosis unit is configured to diagnose the overcurrent state as a first level of overcurrent.

3. The apparatus according to claim 2, wherein the highest fuse temperature in each area on the discharging power map of the battery is determined based on a state of health (SOH) of the battery.

4. The apparatus according to claim 2, wherein the predetermined threshold is set based on a charging overcurrent condition of the battery.

5. The apparatus according to claim 1, wherein based on a change rate of the measured fuse temperature being equal to or higher than a predetermined first threshold, the overcurrent diagnosis unit is configured to diagnose the overcurrent state as a second level of overcurrent.

6. The apparatus according to claim 5, further comprising:
a battery control unit configured to block a current flow of the battery based on the overcurrent state being determined as the second level of overcurrent.

7. The apparatus according to claim 6, wherein based on the change rate of the measured fuse temperature being lower than a second threshold after blocking the current flow of the battery, the battery control unit is configured to recover the current flow of the battery.

8. A method for diagnosing a battery overcurrent, the method comprising:
measuring a temperature of a fuse through which a current of a battery flows; and
diagnosing an overcurrent state of the battery based on a measured fuse temperature.

9. The method according to claim 8, wherein diagnosing the overcurrent state of the battery includes, based on the measured fuse temperature being higher than a highest fuse temperature in each area on a discharging power map of the battery by a predetermined threshold or more, diagnosing the overcurrent state as a first level of overcurrent.

10. The method according to claim 9, wherein the highest fuse temperature in each area on the discharging power map of the battery is determined based on a state of health (SOH) of the battery.

11. The method according to claim 9, wherein the predetermined threshold is set based on a charging overcurrent condition of the battery.

12. The method according to claim 8, wherein diagnosing the overcurrent state of the battery includes, based on a change rate of the measured fuse temperature being equal to or higher than a predetermined first threshold, diagnosing the overcurrent state as a second level of overcurrent.

13. The method according to claim 12, further comprising:
blocking a current flow of the battery based on the overcurrent state being determined as the second level of overcurrent.

14. The method according to claim 13, further comprising:
recovering the current flow of the battery based on the change rate of the measured fuse temperature being lower than a second threshold after blocking the current flow of the battery.

15. An apparatus for diagnosing a battery overcurrent, the apparatus comprising:
a fuse temperature measurement unit configured to measure a temperature of a fuse through which a current of a battery flows; and
an overcurrent diagnosis unit configured to determine a overcurrent level of an overcurrent state of the battery based on a measured fuse temperature.

16. The apparatus according to claim 15, wherein the overcurrent diagnosis unit is configured to divide the overcurrent state of the battery into a plurality of overcurrent levels.

17. The apparatus according to claim 16, wherein the overcurrent state of the battery is divided into the plurality of overcurrent levels based on an overcurrent magnitude.

18. The apparatus according to claim 16, wherein the overcurrent state of the battery is divided into the plurality of overcurrent levels based on a risk level.

19. The apparatus according to claim 15, wherein based on the measured fuse temperature being higher than a highest fuse temperature in each area on a discharging power map of the battery by a predetermined threshold or more, the overcurrent diagnosis unit is configured to diagnose the overcurrent state as a first level of overcurrent.

20. The apparatus according to claim 15, wherein based on a change rate of the measured fuse temperature being equal to or higher than a predetermined first threshold, the overcurrent diagnosis unit is configured to diagnose the overcurrent state as a second level of overcurrent.
